(19) United States
(12) Patent Application Publication
(10) Pub. No.: US 2016/0364816 A1
(43) Pub. Date: Dec. 15, 2016

(54) GENERATING COPYRIGHT PROTECTABLE MEDIA

(71) Applicant: Media Rights Technologies, Inc., Santa Cruz, CA (US)

(72) Inventor: Hank Risan, Santa Cruz, CA (US)

(21) Appl. No.: 14/736,085

(22) Filed: Jun. 10, 2015

(51) Int. Cl. G06Q 50/18; G06Q 10/10

(52) U.S. Cl. CPC G06Q 50/184; G06Q 10/10

(57) ABSTRACT

A method and system for generating copyright protectable media is disclosed. One embodiment selects a media recording and generates a non-infringing reproduction of the media recording. An artistic modification is performed on the non-infringing reproduction of the media recording to form an original independent work of authorship. A simulation of the original independent work of authorship is generated the simulation being an original independent work of authorship. The original independent work of authorship is recorded.

### BACKGROUND

If the downloaded media is copyright protected, copyright royalties are required to be paid each time a copy of the media is sold. For example, if a copy of a copyrighted media recording is sold, the party selling the copy of the media is required to pay copyright royalties such as a performance royalty and a publishing royalty. Generally, the performance royalty is paid to the performers and producers of the media while the publishing royalty is paid to the artist who wrote the media. However, if media is not copyright protected, then no royalties are collected.

### BRIEF DESCRIPTION OF THE DRAWINGS

FIG. 1 is a flow chart of a method for generating copyright protectable media in accordance with an embodiment of the present invention.

FIG. 2 is a block diagram of a copyright protectable media generator with entirely independent artistic authorship in accordance with an embodiment of the present invention.

FIG. 3A is a block diagram of a simulation of a media recording with artistic authorship in a virtual environment in accordance with an embodiment of the present invention.

FIG. 3B is a block diagram of a simulation of a media recording with artistic authorship in a different virtual environment in accordance with an embodiment of the present invention.

FIG. 4 is a flow chart of a method for simulation of a media recording with artistic authorship in accordance with an embodiment of the present invention.

FIG. 5A is a diagram of a physical DJ booth in accordance with an embodiment of the present invention.

FIG. 5B is a diagram of a virtual DJ booth in accordance with an embodiment of the present invention.

FIG. 6 is a block diagram of a system for generating a simulation of an original independent work of authorship, the simulation also being an original independent work of authorship in accordance with an embodiment of the present invention.

FIG. 7 is a block diagram of a computer system in accordance with an embodiment of the present invention.

The drawings referred to in this description should be understood as not being drawn to scale except if specifically noted.

### DESCRIPTION OF EMBODIMENTS

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following Description of Embodiments, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### NOTATION AND NOMENCLATURE

Unless specifically stated otherwise as apparent from the following discussions, it is appreciated that throughout the present Description of Embodiments, discussions utilizing terms such as “selecting”, “determining”, “outputting”, “generating”, “providing”, “receiving”, “utilizing”, “obtaining”, “recording”, “accessing”, “performing,” or the like, often refer to the actions and processes of an electronic computing device/system, such as a computing system. The electronic computing device/system manipulates and transforms data represented as physical (electronic) quantities within the circuits, electronic registers, memories, logic, processor(s), and/or components and the like of the electronic computing device/system into other data similarly represented as physical quantities within the electronic computing device/system or other electronic computing devices/systems.

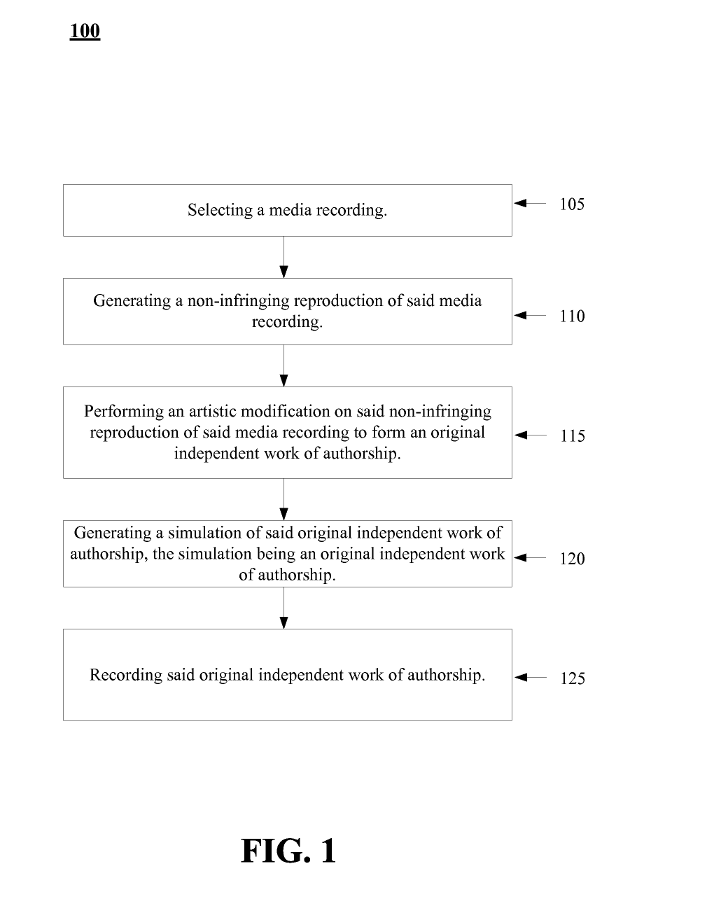

With reference to FIG. 1, a flowchart 100 of a method for generating copyright protectable media in accordance with one embodiment of the present technology. For example, a copyright owner receives a number of exclusive rights. However, without a copyright, the owner, artist or developer of a media recording is essentially donating the media recording to the public. The discussion herein provides a number of embodiments for generating copyright protectable media.

Referring now to 105 of FIG. 1, one embodiment selects a media recording such as media recording 240. In one embodiment, media recording 240 is in binary format such as in the form of a WAV file. In another embodiment, media recording 240 may be MPEG, JPEG, MP3 or any other audio or visual media format.

With reference now to 110 of FIG. 1, one embodiment generates a non-infringing reproduction of the media recording 240. In general, a non-infringing reproduction 250 refers to any media recording that does not infringe on the copyright of another. In one embodiment, a non-infringing reproduction 250 may be an independent work of authorship, an original work, a parody, or any media recording that does not infringe upon the copyright of another. In one embodiment, non-infringing reproduction 250 is in binary format such as in the form of a WAV file. In another embodiment, non-infringing reproduction 250 may be MPEG, JPEG, MP3 or any other audio or visual media format.

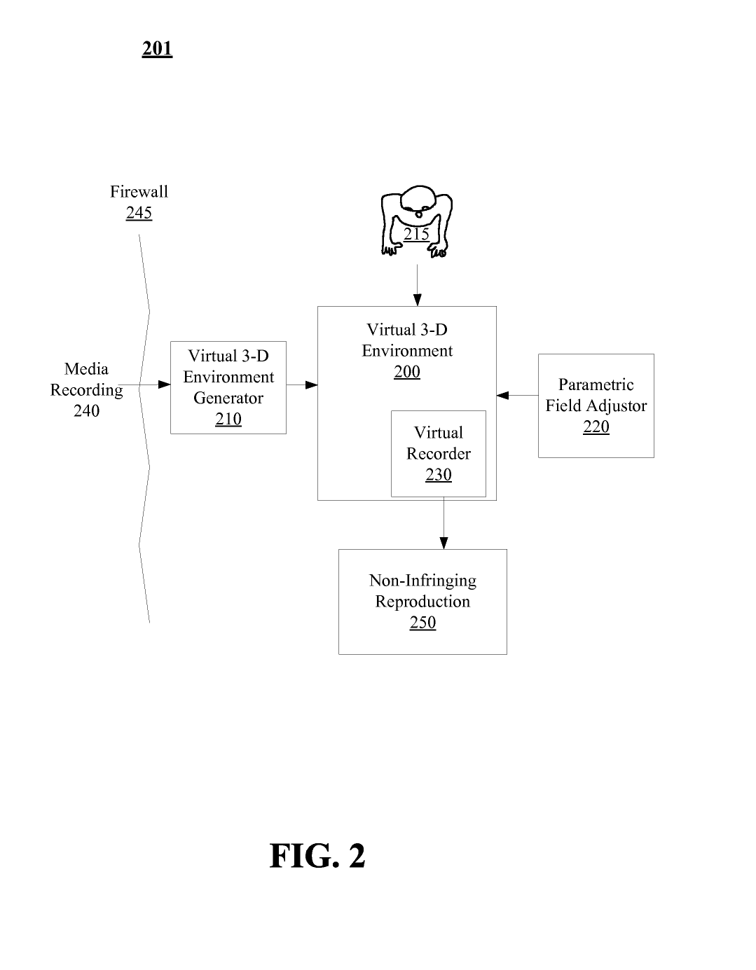

With reference now to FIG. 2, a copyright protectable media generator is shown in accordance with one embodiment of the present technology. FIG. 2 includes a plurality of components such as media recording 240, firewall 245, virtual 3-D environment generator 210, virtual 3-D environment 200, operating artist 215, parametric field adjustor 220, virtual recorder 230 and non-infringing reproduction 250. Although a number of components are described in FIG. 2, they are shown according for clarity with respect to one embodiment of the present technology. However, the present technology is well suited to alternate embodiments that may include more, fewer or different components.

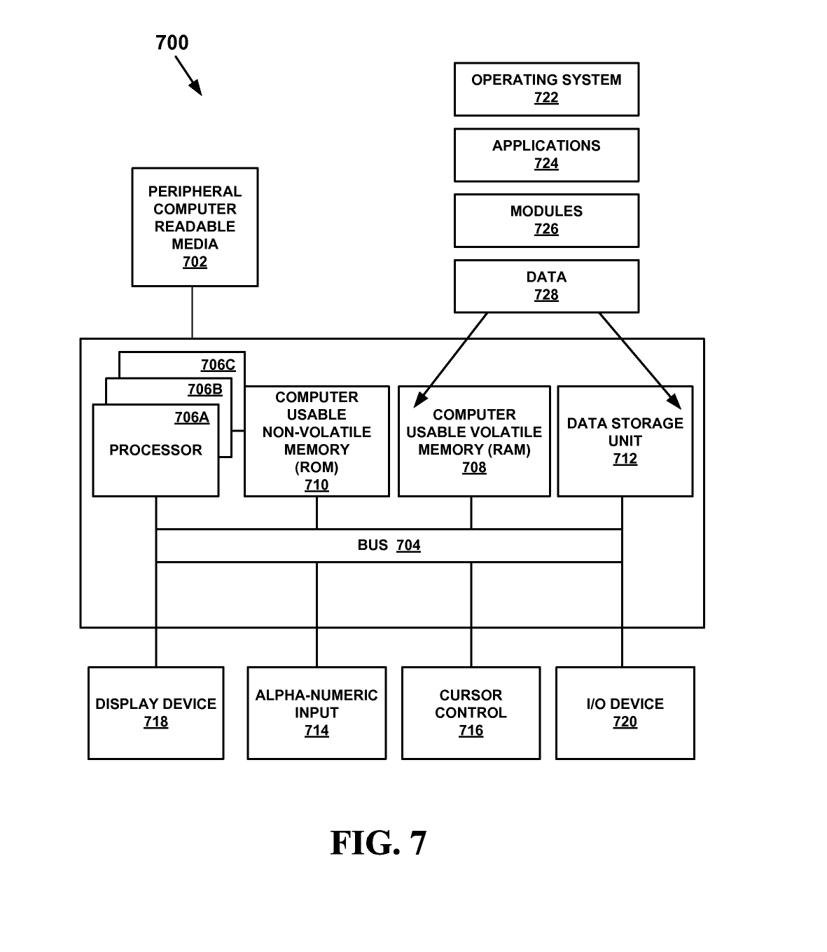

In general, one or more, or a portion of one or more, of the components of FIG. 2 may reside in a computer-readable and computer-executable instructions which reside, for example, in computer-usable media of a computer system, such as but not limited to the computer system 700 of FIG. 7.

In another embodiment, one or more, or a portion of one or more, of the components of FIG. 2 may be installed as software and/or hardware and utilized on any device that is capable of accessing music and/or media, such as a personal computer (PC), a laptop, a player/record, and a mobile device, among other things. Player/recorders may be digital, such as MP3 players. Examples of mobile devices include MP3 players, laptops, mobile phones, and portable computing devices, among other things.

In general, virtual 3-D environment generator 210 receives a media recording 240. In one embodiment, virtual 3-D environment generator 210 has sufficient rights to obtain media recording 240. In one embodiment, the sufficient rights may be permission by the owner of the copyright of media recording 240. In another embodiment, the sufficient rights are acquired by a mechanical license. A mechanical license allows for limited rights, such as, but not limited to, making a one-time copy for analytical study of the components of that media recording 240. In one embodiment, the copy of media recording 240 is in binary format such as in the form of a WAV file. However, media recording 240 is also well suited to being MPEG, JPEG, MP3 or any other audio or visual media.

In one embodiment, virtual 3-D environment 200 in conjunction with operating artist 215 and parametric field adjustor 220 are utilized to generate a non-infringing reproduction 250. In other words, as described in more detail herein, non-infringing reproduction 250 is not a mix, recasting, digitization or imitation of media recording 240 but is instead a new audio/visual performance, the independent work of operating artist 215, e.g., a performing artist and a producer providing artistic modification input.

In one embodiment, such as for security purposes, firewall 245 may be implemented prior to virtual 3-D environment generator 210 to ensure that the output of virtual 3-D environment 200 is a non-infringing reproduction 250 that is wholly new and independent expression of operating artist 215 as opposed to a mere mechanical rendition or manipulation of the media recording 240. In addition, firewall 245 can selectively allow for copying if the proper rights are granted by the copyright holder. In yet another embodiment, firewall 245 can be implemented prior to virtual 3-D environment 200.

Moreover, in another embodiment firewall 245 may be located in numerous different locations to ensure that the output of virtual 3-D environment 200 is a non-infringing reproduction 250 that is wholly new and independent expression of operating artist 215 as opposed to a mere mechanical rendition or manipulation of the media recording 240. Further, a plurality of firewalls 245 may be utilized. However, for purposes of clarity one of the pluralities of locations for firewall 245 is shown in FIG. 2.

With reference again to FIG. 2, in one embodiment, parametric field adjustor 220 utilizes psychoacoustics, that is, human production and mathematical modeling for the creation of non-infringing reproduction 250. In one embodiment, any psychoacoustic or psychovisual modeling can be created by operating artist 215 and performed by parametric field adjustor 220 within virtual 3-D environment 200. Further detail is provided below.

Thus, virtual 3-D environment 200 outputs a non-infringing reproduction 250. Moreover, non-infringing reproduction 250 was not created by duplicating or directly or indirectly recapturing the sounds of media recording 240. Non-infringing reproduction 250 is not a derivative work in which the actual sounds fixed in media recording 240 are rearranged, remixed or otherwise altered in sequence or quality. Instead, non-infringing reproduction 250 is a simulation entirely based upon artistic decision making.

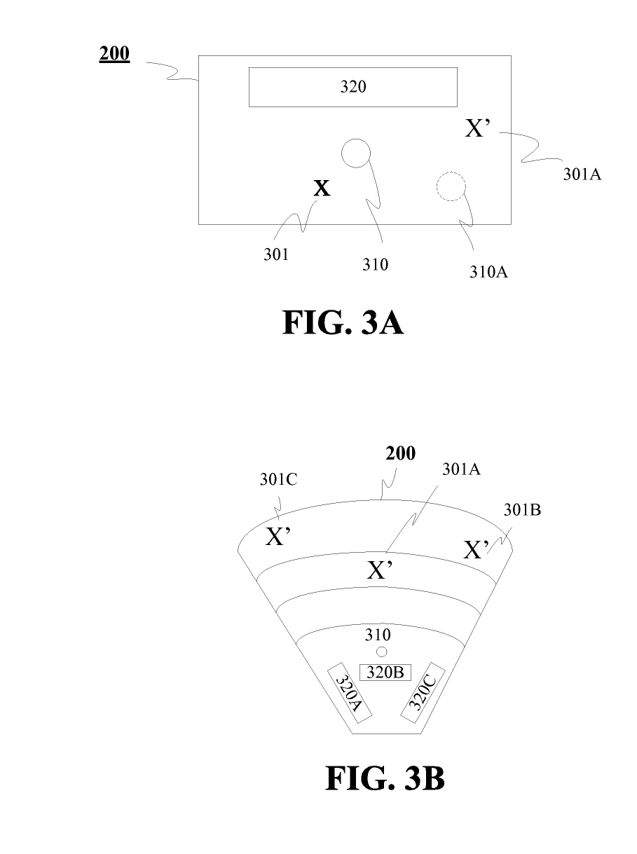

Referring now to FIG. 3A, a block diagram of a psychoacoustic simulation of a media recording with entirely independent artistic authorship in a similar virtual environment is shown in accordance with an embodiment of the present invention. FIG. 3A includes virtual 3-D environment 200, at least one original capture point 301, and at least one original source points 310 and 320. In the present embodiment, original source point 310 is a vocalist while original source point 320 is a band.

In addition, virtual 3-D environment 200 of FIG. 3A includes different capture point 301A, but could include multiple capture points as shown in FIG. 3B. In one embodiment, virtual 3-D environment 200 is a similar environment in which media recording 240 was generated. For example, virtual 3-D environment 200 is a studio. Original capture point 301 is the location of the sound recording device, e.g., a microphone, which was utilized during the recording of media recording 240. The source point location of vocalist and band are also virtual recreations suggested by operating artist 215 inputs. Different capture point 301A is the location that was utilized by operating artist 215 within virtual 3-D environment 200 to generate non-infringing reproduction 250.

In one embodiment, different capture point 301A is established by parametric field adjustor 220 adjusting a plurality of parameters of the parametric field within the virtual 3-D environment 200. In general, the pluralities of parameters that make up the parametric field are selected by operating artist 215 from the group including, but not limited to, pitch, loudness, duration of note, timbre and sound stage.

As described in detail herein, by adjusting a plurality of parameters of a parametric field within the virtual 3-D environment 200, artistic options such as changes in pitch, loudness, timbre and duration of note generate a non-infringing reproduction 250. In addition, the establishment of a different capture point 301A allows virtual recorder 230 to generate a non-infringing reproduction 250 that includes reshuffling of band and/or vocalist source point locations within virtual 3-D environment 200.

Although a vocalist and band source points are described in FIGS. 3A and 3B, they are utilized merely for purposes of clarity within the examples. The technology is well suited to generating a virtual environment and non-infringing reproduction 250 that are audio and/or video.

With reference to FIG. 3B, a block diagram of a psychoacoustic simulation of a media recording with artistic authorship in different virtual 3-D environments 200 are shown. One major distinction with respect to both virtual 3-D environments of FIGS. 3A and 3 B is the modification of the original location at which media recording 240 was made. In other words, in the present example, media recording 240 was generated in a closed recording studio. However, in FIG. 3B, operating artist 215 in conjunction with parametric field adjustor 220, artistically adjusted a plurality of parametric fields within the virtual 3-D environments of FIG. 3B. In other words, non-infringing reproduction 250 simulates the generation of the recording in a concert hall, arena, ballpark, or other venue. In addition, as shown in virtual 3-D environment 200 of FIG. 3B, original source point 320 has been separated into three different source points 320A, 320B and 320C. Further, three different source points 320A, 320B and 320C have been moved within the virtual 3-D environment 200 of FIG. 3B to generate non-infringing reproduction 250.

In addition, virtual 3-D environment 200 of FIG. 3B shows additional artistic options including a number of possible locations for one or more different capture points, e.g., 301A, 301B and 301C. Moreover, virtual 3-D environment 200 of FIG. 3B shows another arrangement of three different source points 320A, 320B and 320C. Specifically, virtual 3-D environment 200 of FIG. 3B, shows different source point 320B having significantly more input into non-infringing reproduction 250 than different source point 320B of virtual 3-D environment 200 of FIG. 3A.

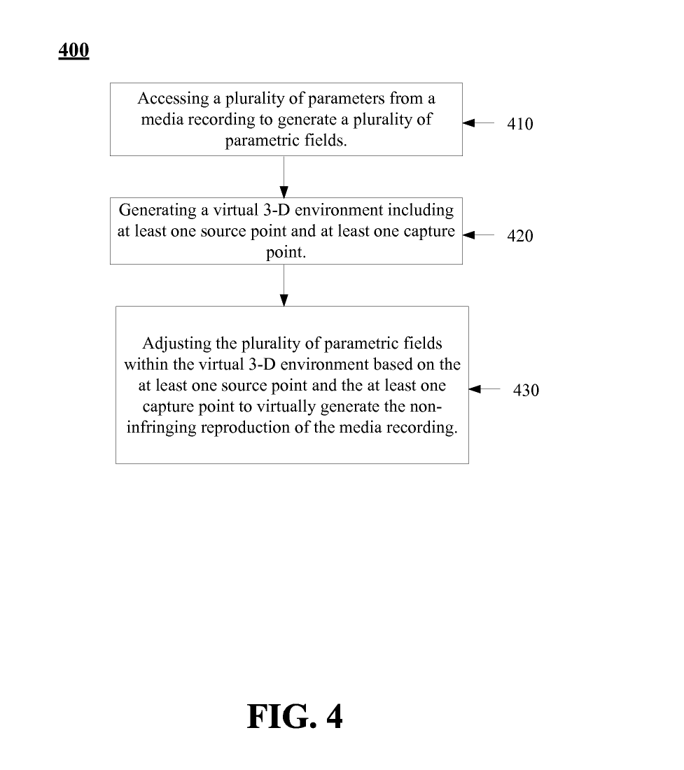

With reference now to FIG. 4 and also FIGS. 2 and 3A, a flow chart of a method for psychoacoustic simulation of a media recording is shown in accordance with an embodiment of the present invention. Specifically, non-infringing reproduction 250 is not a mix of a previously recorded song. Nor are effects added to an original recording to generate non-infringing reproduction 250. Instead, the present technology generates a different non-infringing reproduction 250. For example, the present technology provides a version of media that is fundamentally different based on the artist's new desire, artistic ear, and the like as parametric field adjustor 220 is operated to create a new product.

With reference now to 410 of FIG. 4, one embodiment accesses a plurality of parameters from the media recording to generate the parametric fields. In one embodiment, the pluralities of parameters that make up the parametric fields are selected from the group including, but not limited to, pitch, loudness, duration of note, timbre and sound stage.

In one embodiment, sound stage is the specific venue in which the recording of the work is made. The sound stage has a number of attributes, which include (but are not limited to) the following:
Whether the venue is enclosed or otherwise bounded
The shape of the venue
The acoustically reflective properties of the bounding materials for the venue
The location(s) of any wall(s), furniture, or other obstructions within the venue that can reflect sound.

For example, a bounded venue can be rectangular, consisting of four walls placed at right angles, with a floor and ceiling that is uniformly parallel to the floor. The venue could also have walls that are skewed, thus yielding a non-rectangular shape, or the ceiling might be vaulted or sloped. The venue could also have recessed storage areas. Each of these attributes would result in different acoustical characteristics. Concert halls and other performance venues will have similar attributes.

Referring now to 420 of FIG. 4 and to FIGS. 3A and 3B, one embodiment generates a virtual 3-D environment 200 including at least one source point 320A and at least one capture point 301A. In another embodiment, a plurality of source point 320A-320C and a plurality of capture points 301A-301C may be included within virtual 3-D environment 200.

With reference now to 430 of FIG. 4 and to FIGS. 3A and 3B, one embodiment adjusts the plurality of parametric fields within virtual 3-D environment 200 based on the at least one source point 310A and the at least one capture point 301A to generate the non-infringing reproduction of the media recording.

For example, the methodology is similar to that of a number of different conductors leading the same orchestra. Each conductor will interpret and perform media recording 240 in a different fashion. For example, one conductor may prefer more brass while another conductor may prefer more percussion. Yet another conductor may utilize cannon, while a fourth conductor may wish to emphasize a cowbell.

Therefore, although each conductor may have initially selected the same piece of music to conduct, each performance would be significantly different and recognizable based on the conductor's own artistic interpretations. In fact, it is quite reasonable to assume that over a period of time each conductor would place enough of his or her own artistic personality within their interpretations of the music such that upon hearing an orchestra play, a listener may be able to identify the conductor.

It is the same general principle of providing ones' own interpretation to the media (audio and/or video) that is utilized herein. That is, the resultant non-infringing reproduction 250 is not a mix or a copy of previous work, but is instead a new interpretation and therefore a new work. For example, non-infringing reproduction 250 may have emphasized the brass section and deemphasized the woodwind section, increased the pitch of the voice, decreased the level of the base, and the like. Moreover, it is well within the present technology to generate a non-infringing reproduction 250 that has never previously been possible. For example, generating a non-infringing reproduction 250 that utilizes the artist's interpretation of Frank Sinatra singing a song that was not published until after his death.

In other words, media recording 240 is not copied, but is instead taken all the way back prior to the initial production and a new work created at the production level to produce a distinctly different version that is based on the interpretation and personality of operating artist 215 utilizing virtual 3-D environment 200 in conjunction with parametric field adjustor 220 to generate a non-infringing reproduction 250.

For example, musical tones are produced by musical instruments or by the voice to create a sequence of pressurized spherical waves which propagate through air to the ears and convert into action potentials for the brain to process. Every musical sound in a sound recording has a point of origin called the source point. For example, in a recording of say a string quartet, there are 4 voices that are performing spatially in a 3-D sound stage. Based on a subjective analysis of the sound recording, an entirely new performance is generated by creating new voicings from specific source points in a 3-D sound stage determined by the producer.

In one embodiment, a producer performs an analysis on a copy of media recording 240 from at least 5 parameters—pitch, loudness, duration of note, timbre and sound stage. The copy of media recording 240 is then destroyed. Utilizing psychoacoustics, human authorship and advanced simulation topology, a new source point sound stage presentation with entirely new voices having different timbre, pitch, loudness and duration of note is created. The different capture point 301A is then utilized within the virtual 3-D environment 200 to generate a new performance based entirely on artistic subjective interpretation.

For example, in simulating Sinatra's voice a different timbre is used in a BlueBeat.com performance than what was originally created on the CD. The different timbre is a subjective interpretation of Sinatra's timbre based on knowledge of sound propagation of waves and the distortions of recording and digitization of operating artist 215. In other words, the new work is intended to capture the illusion of a live performance as might have been heard before the engineers started mechanically manipulating and the reproduction process started distorting Sinatra's actual voice. Thus, it is not actually Sinatra's voice that is being heard on BlueBeat.com™. Instead, it is an artistic interpretation as to what he might have sounded like in the eyes of a new author. Moreover, it is not necessarily just the timbre of Sinatra's voice that may be subjectively interpreted. The artistic interpretation may also increase or reduce the influence of a particular instrument, a back-up vocal, or even add or remove sounds or instruments all together within the construct of an independently created sound stage.

As such, what is created is not a mix or copy of an original media recording. Instead, the result is a psychoacoustic illusion of a performance that in one embodiment may sound similar to a live musical performance instead of a studio track. In another embodiment, the result will be an entirely independent work created by the author that embodies a psychoacoustic illusion of a performance that reduced the influence of an over aggressive horn player or increased the influence of a back-up singer that was initially understated in the opinion of the producer without using the original sounds fixed in the underlying work. In so doing, what is created is a new non-infringing reproduction 250.

Again, utilizing the previous conductor example, each conductor has their own understanding as to the strengths and weaknesses of a particular piece of music as well as the strengths and weaknesses of the performers performing the piece. As stated herein, a conductor's own personality will emanate through the music making it quite distinguishable from the work of another conductor. However, it is not only the conductor's personality that generates the new non-infringing reproduction 250. There is also significant input and/or output from the actual performers being conducted as well as the location of the listener or recording device.

For example, in one performance, the conductor may notice that a particular musician or an entire section is performing at a higher level than normal. The conductor may recognize the higher level of performance and adjust his or her conducting with an entirely independent fixation of new sounds to better utilize the inspired performer or performers. Similarly, the conductor may recognize a performer having an off day and adjust his or her conducting to reduce the effect of the performer on the overall piece of work all done with new simulated sounds. This provides great latitude in artistic creation.

However, it is also quite possible that the conductor will not notice a performer having an inspired and/or off day until later in the performance or not at all. The present technology allows a different conductor the opportunity to return to the performance and single out the performer from the beginning. Thus, in one embodiment, the present technology will allow an operating artist 215 to emphasize a performer having a performance of a lifetime or deemphasize a performer having an off day.

For example, if a piece of media were recorded from a location, such as too close to the singer, with a faulty microphone or the like, operating artist 215 in conjunction with parametric field adjustor 220 operating within virtual 3-D environment 200 is capable of utilizing any or all of the media parameters, such as but not limited to pitch, loudness, duration of note, timbre and sound stage, to adjust the virtual ear location. For all intents and purposes, the subjective and artistic interpretation would be a reflection of the individual interpreting or conducting the non-infringing reproduction 250. In other words, virtual 3-D environment 200 allows operating artist 215 to provide their own influence and personality to generate non-infringing reproduction 250 in a fashion similar to that of a conductor, sound engineer or the like.

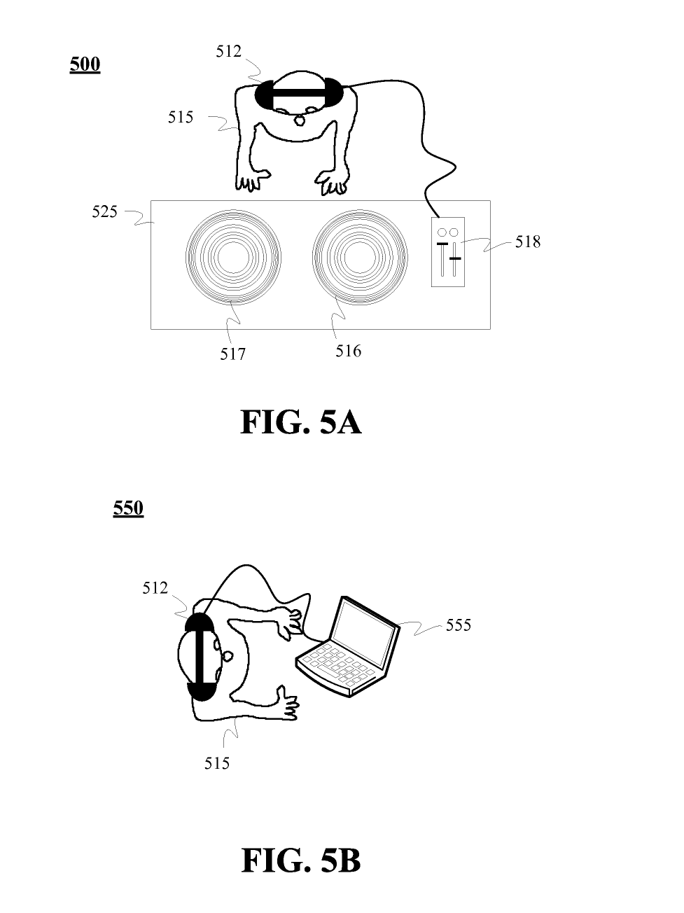

With reference now to 115 of FIG. 1 and FIGS. 5A and 5B, one embodiment performs an artistic modification on the non-infringing reproduction 250 of the media recording to form an original independent work of authorship 610. In other words, the artistic manipulation performed on non-infringing reproduction 250 results in an original work of authorship 610.

In general, the artistic modification to non-infringing reproduction 250 includes, but should not be limited to, mixing, tempo adjustments, pitch modification, gain control, fade, addition or removal of effects, crossfade, bass adjustment, echo, treble adjustment, addition of loops, scratching, reverb, length, speed adjustments, and the like. Thus, DJ 515 provides her own artistic talents in conjunction with the non-infringing reproduction 250 to produce an original work, e.g., original independent work of authorship 610. For example, DJ 515 may manipulate the non-infringing reproduction 250 by slowing the tempo at a first portion, increase the tempo at a second portion, adding in an instrument such as a clarinet, mix other non-infringing music into a third portion, add base to a fourth portion and the like. Although the previous example provides only one change to each portion, it should be appreciated that a DJ 515 may perform a plurality of artistic manipulations to one or more portions of non-infringing reproduction 250. In other words, in the above example, in addition to increasing the tempo at the second portion, DJ 515 may also add base and a saxophone to the second portion of non-infringing reproduction 250.

In one embodiment, DJ 515 may artistically manipulate only one aspect of non-infringing reproduction 250. In another embodiment, DJ 515 may artistically manipulate only some portions of non-infringing reproduction 250. In yet another embodiment, DJ 515 may artistically manipulate a reasonable portion of non-infringing reproduction 250. In yet another embodiment, DJ 515 may artistically manipulate most of non-infringing reproduction 250. In one embodiment, DJ 515 may artistically manipulate approximately all of non-infringing reproduction 250.

In one embodiment, such as shown in 500 of FIG. 5A, the artistic medication may be performed by a DJ 515 providing artistic interpretation via a physical DJ booth 525. In one embodiment, the physical DJ booth 525 includes controller 518, turntables 516 and 517 and headphones 512. Although one type of physical DJ booth is shown in FIG. 5A, the technology is not limited to the layout shown. It is merely one of a plurality of possible physical DJ booth 525 type layouts.

In FIG. 5B, a virtual DJ booth 550 is shown. In one embodiment, the DJ 515 performs the artistic manipulation in a virtual DJ environment. In one embodiment, DJ 515 may access the virtual DJ booth via a computing device 555. Although a laptop type computing device 555 is shown, the virtual DJ booth may be arranged to look like the turntable of FIG. 5A. In another embodiment, the virtual DJ booth may be accessed via a desktop, notebook, tablet, smart phone or other device.

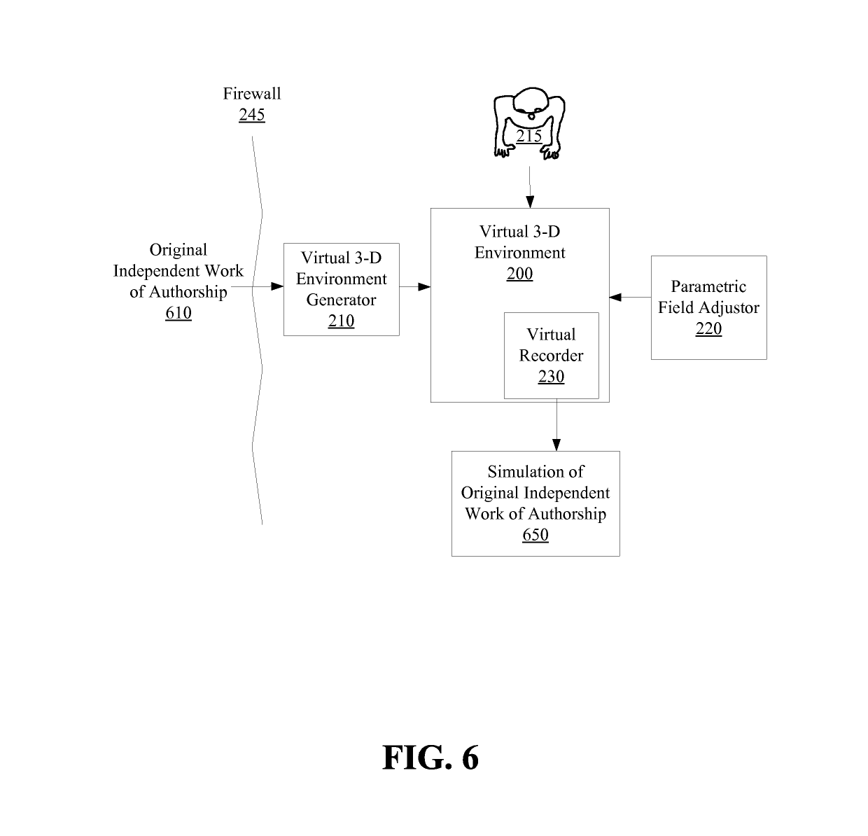

With reference now to 120 of FIG. 1 and to FIG. 6, one embodiment generates a simulation of the original independent work of authorship 610, the simulation also being an original independent work of authorship. For example, as shown in FIG. 6, after the DJ has performed the artistic manipulation with non-infringing reproduction 250 to produce original independent work of authorship 610; the original independent work of authorship 610 is subjected to the media recording simulator 201 described in FIGS. 2-4 herein.

Upon completion of the simulation process, the discussion of which is not repeated for purposes of clarity, the resulting simulation of entirely original independent work of authorship 650 is achieved. As such, the resultant simulation of entirely original independent work of authorship 650 would be able to receive copyright protection.

With reference now to 125 of FIG. 1, one embodiment records the simulation of entirely original independent work of authorship 650. In one embodiment, simulation of entirely original independent work of authorship 650 is recorded in a binary format such as in the form of a WAV file. However, in another embodiment, simulation of entirely original independent work of authorship 650 may be MPEG, JPEG, MP3 or other audio or visual media format.

### Example Computer System Environment

With reference now to FIG. 7, portions of the technology for providing computer-readable and computer-executable instructions that reside, for example, in or on a non-transitory computer readable medium of a computer system. That is, FIG. 7 illustrates one example of a type of computer that can be used to implement one embodiment of the present technology.

Although computer system 700 of FIG. 7 is an example of one embodiment, the present technology is well suited for operation on or with a number of different computer systems including general purpose networked computer systems, embedded computer systems, routers, switches, server devices, user devices, various intermediate devices/artifacts, stand alone computer systems, mobile phones, personal data assistants, and the like.

In one embodiment, computer system 700 of FIG. 7 includes peripheral computer readable media 702 such as, for example, a floppy disk, a compact disc, and the like coupled thereto.

Computer system 700 of FIG. 7 also includes an address/data bus 704 for communicating information, and a processor 706A coupled to bus 704 for processing information and instructions. In one embodiment, computer system 700 includes a multi-processor environment in which a plurality of processors 706A, 706B, and 706C are present. Conversely, computer system 700 is also well suited to having a single processor such as, for example, processor 706A. Processors 706A, 706B, and 706C may be any of various types of microprocessors. Computer system 700 also includes data storage features such as a computer usable volatile memory 708, e.g. random access memory (RAM), coupled to bus 704 for storing information and instructions for processors 706A, 706B, and 706C.

Computer system 700 also includes computer usable non-volatile memory 710, e.g. read only memory (ROM), coupled to bus 704 for storing static information and instructions for processors 706A, 706B, and 706C. Also present in computer system 700 is a data storage unit 712 (e.g., a magnetic or optical disk and disk drive) coupled to bus 704 for storing information and instructions. Computer system 700 also includes an optional alpha-numeric input device 714 including alpha-numeric and function keys coupled to bus 704 for communicating information and command selections to processor 706A or processors 706A, 706B, and 706C. Computer system 700 also includes an optional cursor control device 716 coupled to bus 704 for communicating user input information and command selections to processor 706A or processors 706A, 706B, and 706C. In one embodiment, an optional display device 718 is coupled to bus 704 for displaying information.

Referring still to FIG. 7, optional display device 718 of FIG. 7 may be a liquid crystal device, cathode ray tube, plasma display device or other display device suitable for creating graphic images and alpha-numeric characters recognizable to a user. Optional cursor control device 716 allows the computer user to dynamically signal the movement of a visible symbol (cursor) on a display screen of display device 718. Implementations of cursor control device 716 include a touchscreen, trackball, mouse, virtual mouse, touch pad, joystick or special keys on alpha-numeric input device 714 capable of signaling movement of a given direction or manner of displacement. Alternatively, in one embodiment, the cursor can be directed and/or activated via input from alpha-numeric input device 714 using special keys and key sequence commands or other means such as, for example, voice commands, gestures, and the like.

Computer system 700 also includes an I/O device 720 for coupling computer system 700 with external entities. In one embodiment, I/O device 720 may include wired serial adaptors, modems, and network adaptors, wireless modems, and wireless network adaptors, and other such communication technology for enabling wired or wireless communications between computer system 700 and an external network such as, but not limited to, the Internet. In one embodiment, I/O device 720 may include a serial port, parallel port, Universal Serial Bus (USB), Ethernet port, Bluetooth, thunderbolt, near field communications port, WiFi, Cellular modem, or other input/output interface. Moreover, I/O device 720 may physically, electrically, optically, or wirelessly (e.g., via radio frequency) couple system 700 with another device, such as a cellular telephone, radio, or computer system.

Referring still to FIG. 7, various other components are depicted for computer system 700. Specifically, when present, an operating system 722, applications 724, modules 726, and data 728 are shown as typically residing in one or some combination of computer usable volatile memory 708, e.g. random access memory (RAM), and data storage unit 712. However, in an alternate embodiment, operating system 722 may be stored in another location such as on a network or on a flash drive. Further, operating system 722 may be accessed from a remote location via, for example, a coupling to the Internet, a network or the like.

In one embodiment, the present technology is stored as an application 724 or module 726 in memory locations within RAM 708 and memory areas within data storage unit 712.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Although a number of embodiments have been described in terms of music, aspects described herein may be used for any form of media, such as music, movies, videos, DVDs, CDs, books, documents, graphics, etc.

Although “accessing” has been defined in terms of playing music, transmitting music, copying music, etc., “accessing” may also include displaying media, for example, in the case of movies, DVDs, books, graphics, and documents.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for generating copyright protectable media, said method comprising:
selecting a media recording;
generating a non-infringing reproduction of said media recording;
performing an artistic modification on said non-infringing reproduction of said media recording to form an original independent work of authorship;
generating a simulation of said original independent work of authorship; and
recording the simulation of said original independent work of authorship.

2. The method of claim 1 wherein generating said non-infringing reproduction of said media recording comprises:
accessing a plurality of parameters from said media recording to generate a plurality of parametric fields;
generating a virtual 3-D environment including at least one source point and at least one capture point; and
adjusting said plurality of parametric fields within said virtual 3-D environment based on said at least one source point and said at least one capture point to virtually generate the non-infringing reproduction of said media recording.

3. The method of claim 2, wherein said plurality of parametric fields is selected from the group consisting of: pitch, loudness, duration of note, timbre and sound stage.

4. The method of claim 1, further comprising:
utilizing an operating artist to perform said artistic modification on said non-infringing reproduction of said media recording in a physical DJ booth.

5. The method of claim 4, wherein said artistic modification is selected from one or more media recording adjustments from the group consisting of: reverb, timing, length, tempo and speed.

6. The method of claim 1, further comprising:
utilizing an operating artist to perform said artistic modification on said non-infringing reproduction of said media recording in a virtual DJ booth.

7. The method of claim 1 wherein generating said simulation of said original independent work of authorship comprises:
accessing a plurality of parameters from said original independent work of authorship to generate a plurality of parametric fields;
generating a virtual 3-D environment including at least one source point and at least one capture point; and
adjusting said plurality of parametric fields within said virtual 3-D environment based on said at least one source point and said at least one capture point to virtually generate an entirely original independent work of authorship.

8. A copyright protectable media generator comprising:
a media recording simulator to generate a non-infringing reproduction of a media recording;
an artistic modification input to provide an artistic modification on said non-infringing reproduction of said media recording to form an original independent work of authorship;
said media recording simulator to generate a simulation of said original independent work of authorship; and
a virtual recorder to record the simulation of said original independent work of authorship.

9. The copyright protectable media generator of claim 8 wherein the media recording simulator comprises:
a parametric field adjustor to access a plurality of parameters from said media recording and generate a plurality of parametric fields;
a virtual 3-D environment generator for generating a virtual 3-D environment, said virtual 3-D environment including at least one original source point and at least one original capture point; and
a parametric field adjustor for adjusting a plurality of parameters of said parametric field within said virtual 3-D environment based on said at least one source point and said at least one capture point to virtually generate the non-infringing reproduction of said media recording.

10. The copyright protectable media generator of claim 9, wherein said plurality of parametric fields is selected from the group consisting of: pitch, loudness, duration of note, timbre and sound stage.

11. The copyright protectable media generator of claim 8, wherein said artistic modification input comprises:
a physical DJ booth utilized by an operating artist to perform said artistic modification on said non-infringing reproduction of said media recording.

12. The copyright protectable media generator of claim 11, wherein said artistic modification is selected from one or more media recording adjustments from the group consisting of: reverb, timing, length, tempo and speed.

13. The copyright protectable media generator of claim 8, wherein said artistic modification input comprises:
a virtual DJ booth utilized by an operating artist to perform said artistic modification on said non-infringing reproduction of said media recording.

14. The copyright protectable media generator of claim 8 wherein the simulation of said original independent work of authorship is copyrightable.

15. A non-transitory computer readable medium having instructions thereon, said instructions causing a processor to perform a method for generating copyright protectable media, said method comprising:
selecting a media recording;
generating a non-infringing reproduction of said media recording;
performing an artistic modification on said non-infringing reproduction of said media recording to form an original independent work of authorship;
generating a simulation of said original independent work of authorship; and
recording the simulation of said original independent work of authorship.

16. The non-transitory computer readable medium of claim 15 wherein generating said non-infringing reproduction of said media recording comprises:
accessing a plurality of parameters from said media recording to generate a plurality of parametric fields;
generating a virtual 3-D environment including at least one source point and at least one capture point; and
adjusting said plurality of parametric fields within said virtual 3-D environment based on said at least one source point and said at least one capture point to virtually generate the non-infringing reproduction of said media recording.

17. The non-transitory computer readable medium of claim 16, wherein said plurality of parametric fields is selected from the group consisting of: pitch, loudness, duration of note, timbre and sound stage.

18. The non-transitory computer readable medium of claim 15, further comprising:
utilizing an operating artist to perform said artistic modification on said non-infringing reproduction of said media recording in a physical DJ booth.

19. The non-transitory computer readable medium of claim 18, wherein said artistic modification is selected from one or more media recording adjustments from the group consisting of: reverb, timing, length, tempo and speed.

20. The non-transitory computer readable medium of claim 15, further comprising:
utilizing an operating artist to perform said artistic modification on said non-infringing reproduction of said media recording in a virtual DJ booth.

21. The non-transitory computer readable medium of claim 15 wherein generating said simulation of said original independent work of authorship comprises:
accessing a plurality of parameters from said original independent work of authorship to generate a plurality of parametric fields;
generating a virtual 3-D environment including at least one source point and at least one capture point; and
adjusting said plurality of parametric fields within said virtual 3-D environment based on said at least one source point and said at least one capture point to virtually generate an entirely original independent work of authorship.
